(19) United States
(12) Patent Application Publication
(10) Pub. No.: US 2006/0082671 A1
(43) Pub. Date: Apr. 20, 2006

(54) Clock generation circuit and charge coupled device driving circuit

(75) Inventor: Masaaki Ohashi, Ogaki-shi (JP)

Correspondence Address: OLIFF & BERRIDGE, PLC, P.O. BOX 19928, ALEXANDRIA, VA, 22320, US

(73) Assignee: SANYO ELECTRIC CO., LTD., Osaka (JP)

(21) Appl. No.: 11/244,057

(22) Filed: Oct. 6, 2005

(30) Foreign Application Priority Data
Oct. 15, 2004 (JP) 2004-300914

(51) Int. Cl. H04N 5/335

(52) U.S. Cl. 348/312

(57) ABSTRACT

In a CCD driving circuit, it is difficult to reduce the consumption power while maintaining the charge transfer performance. In this connection, when BUFk switches an output φₖₐ to a clock signal line, firstly, a clock signal line 10₋ₖ is set to a floating state, charge/discharge between the clock signal line 10₋ₖ and a capacitor C is carried out. For instance, electric charges of a clock signal line 10₋₁ of which φ₁ is Vₚ are partially charged to the capacitor C. Before Vₚ is applied to the clock signal line 10₋₂ from BUF2, a potential φ₂ is raised to a potential between Vₚ and 0 when the capacitor C charges the clock signal line 10₋₂. When the BUF2 supplies a current corresponding to a portion of a remaining voltage to the clock signal line 10₋₂, φ₂ can be raised to Vₚ.

### FIELD OF THE INVENTION

This invention relates to a reduction of the consumption power of a clock generation circuit and a driving circuit that drives a CCD (Charge Coupled Device) that is used in an image sensor or the like. Furthermore, this invention relates to a CCD driving circuit with which the transfer efficiency of the CCD can be secured.

### BACKGROUND OF THE INVENTION

A CCD has a plurality of transfer electrodes arranged on a semiconductor substrate along a charge transfer direction. When a voltage is applied to these transfer electrodes in turn, a potential well formed in the semiconductor substrate moves, and thereby electric charges (charge packet) stored in the potential well are transferred along a channel of the CCD.

An operation of applying a voltage to a series of transfer electrodes in turn is carried out by use of transfer clocks of plural phases generated by a driving circuit. A plurality of clock signal lines from the driving circuit is wired to the respective transfer electrodes so as to apply the transfer clocks differed in the phase each other to the series of transfer electrodes in turn. In many cases, the number of phases of the transfer clocks is two to four phases. For reference's sake, in the case of two-phase drive, in order to transfer the charge packet in a constant direction, below each of the transfer electrodes of the respective phases, the difference or gradient in channel potential is incorporated in advance. For instance, below each of the transfer electrodes, both a barrier portion shallow in the channel potential and a storage portion deep in the channel potential are formed. The potential difference in the channel, when the difference in an impurity concentration or a film thickness of a gate oxide is given, can be formed. On the other hand, in the case of three-phase drive or more, in accordance with the transfer clocks, the respective transfer electrodes form a barrier portion and a storage portion alternately to enable to transfer the charge packet.

FIGS. 1 and 2 are schematic diagrams for describing a drive of a three-phase drive CCD according to an existing driving circuit. FIG. 1 is a diagram showing a timing chart of three-phase transfer clocks φ₁ through φ₃ that the driving circuit supplies to the CCD, a horizontal axis showing a time, a vertical axis showing a voltage with a positive direction in an upward direction. FIG. 2 shows channel potentials along a direction of charge transfer at times t1 through t7 shown in FIG. 1. In FIG. 2, in the upper portion of the drawing, an arrangement of the transfer electrodes to which the transfer clocks φ₁ through φ₃ are applied is shown, and the channel potentials below the transfer electrodes are shown with a positive direction in a downward direction in the vertical axis.

In an existing driving circuit, for instance, rectangular waves that becomes 0 V at the off-state and a predetermined positive potential Vₚ at the on-state are supplied through clock signal lines to the transfer electrodes as transfer clocks φ₁ through φ₃. That is, the existing driving circuit charges the transfer electrode by a potential difference Vₚ when the transfer clock comes up, and, when the transfer clock comes down, electric charges charged to the transfer electrode are discharged to an earth to be 0V. Accordingly, there are problems in that an amount of charge/discharge current becomes larger and the consumption power of the driving circuit is large. In particular, for instance, a rise in a transfer clock frequency caused with an increase in the number of pixels in a CCD image sensor makes the problem remarkable. As a countermeasure thereto, so far, the transfer clock is set to a lower voltage.

For reference's sake, as to a driving circuit of a liquid crystal display device, a technology that can reduce the consumption power is disclosed in a patent literature 1 described below. In the driving circuit, a clock is sequentially applied to a vertical selection line to set to an on-voltage, and thereby the respective rows of a group of the liquid crystal display devices arranged two-dimensionally are sequentially selected. FIG. 3 is a circuit diagram of an essential part of the driving circuit according to the technology. To a vertical selection line VSLk corresponding to the k-th row (k=1, 2, 3, . . . ), a buffer BUFk that charges the vertical selection line to an on-voltage Vₚ and a switch Sₖₐ that can set the vertical selection line to a floating state are connected. In addition, between adjacent vertical selection lines VSLk and VSL(k+1), a switch S₍ₖ₊₁₎b is disposed to connect or disconnect therebetween. FIG. 4 is a timing chart showing a state of each of the switches of the driving circuit and a variation of an output signal. Here, φₖₐ denotes an output signal of the BUFk and φₖ denotes an output signal applied to the VSLk. For instance, when the second row after changing VSL1 to Vₚ in accordance with the selection of the first row, the driving circuit turns off both switches S₁ₐ and S₂ₐ and turns on a switch S_{2b}. It follows that electric charges are distributed between the vertical selection lines VSL1 and VSL2. Thereafter, the S₂ₐ is turned on to apply a clock φ₂ from the BUF2 and thereby the VSL2 is charged to Vₚ. In the configuration, owing to the distribution of electric charges between the vertical selection lines due to turning-on of the S_{2b}, the VSL2 is charged to Vₚ/2. Accordingly, the BUF2 is only necessary to charge a remaining voltage of Vₚ/2 to obtain Vₚ. Accordingly, in the liquid crystal driving circuit, the consumption power can be reduced.

As mentioned above, in the existing CCD driving circuit, there is a problem in that the consumption power is relatively large. On the other hand, when a voltage of a transfer clock is lowered as a countermeasure thereto, there is a problem in that, owing to a decrease in the fringe electric field, the charge transfer efficiency is deteriorated.

With regard to the patent literature 1, a liquid crystal display device and a CCD, although common in sequentially applying phase-shifted clocks to drive, are fundamentally different devices from each other. Accordingly, there is difficulty in simply applying the technology of the above-mentioned liquid crystal driving circuit to the CCD driving circuit. If it is forcibly applied, problems typical to the CCD such as the deterioration of the charge transfer efficiency and a decrease in an amount of handling electric charges, which are not present in the liquid crystal display device, may be caused.

For instance, in a liquid crystal display device, when an operation is applied to shift a state where an on-voltage Vₚ is applied to an i-th signal line to a state where the on-voltage is applied to an (i+1)-th signal line, in synchronization with the operation, an operation of setting the i-th signal line to an off-voltage is carried out. The above-mentioned liquid crystal driving circuit fundamentally makes use of switching of on/off between the adjacent signal lines. On the other hand, in the CCD, in synchronization with an operation of turning on an (i+1)-th transfer electrode, an i-th transfer electrode is not necessarily turned off. For instance, FIG. 5 is a schematic diagram showing a temporal variation of a channel potential along a charge transfer direction owing to an existing driving method of a four-phase drive CCD. In FIG. 5, the charge transfer direction is directed rightward. For instance, when a state at a time t1 changes to a state at a time t2, although a transfer clock φ₃ is turned on, a transfer clock φ₂ that is turned on in advance is not turned off. Thus, the drive of the CCD is different from the liquid crystal display device.

When the technology of the above-mentioned liquid crystal driving circuit is applied to the four-phase drive CCD, a temporal variation of a channel potential along a charge transfer direction becomes one such as shown in FIG. 6. At a time t1′, the respective signal lines of transfer clocks φ₂ and φ₃ are connected with a switch to distribute electric charges and thereby, each thereof is set to a voltage Vₚ/2. As a result, channel potentials below the transfer electrodes corresponding to the φ₂ and φ₃ become a shallow potential well. However, in order to transfer the signal charges toward right, it is necessary to apply a voltage Vₚ to the transfer electrodes corresponding to the φ₂ and φ₃ to make both a deep potential well as shown as a state at a time t2. This means that, even when the technology of the above-mentioned liquid crystal driving circuit is applied as-is, the consumption power is not reduced.

On the other hand, when a three-phase drive CCD is driven with clocks φ₁ through φ₃ that are generated by the liquid crystal driving circuit and shown in FIG. 4, the reduction of the consumption power can be expected. A circuit shown in FIG. 3 in this case includes three buffers BUF1 through BUF3, the other end of a switch S_{4b} connected to an output signal line of the BUF3 is connected to an output signal line of the BUF1. As a result, transfer clocks φ₁ through φ₃ shown in FIG. 7 are generated and applied to the transfer electrodes of the respective phases.

FIG. 8 shows channel potentials along a charge transfer direction at times t1 through t7 shown in FIG. 7. In FIG. 8, in an upper portion of the drawing, an arrangement of the transfer electrodes to which the transfer clocks φ₁ through φ₃ are applied is shown, and channel potentials below the transfer electrodes are shown with a downward direction in the vertical axis as a positive direction.

As shown in channel potentials at times t2, t4 and t6 in FIG. 8, when electric charges are distributed between clock signal lines, potential wells continuously formed below two adjacent transfer electrodes become shallower than that owing to an existing CCD driving circuit (times t2, t4 and t6 of FIG. 2). In this case, because a region where signal charges are stored is likely to expand toward a surface of a semiconductor substrate, a problem accompanying an interface level, for instance, a problem such as the deterioration of the transfer efficiency owing to traps may be caused. Furthermore, there is also a problem in that, by an amount by which a depth of a potential well (or a height of a potential barrier 2 partitioning between potential wells) becomes smaller, a handling amount of electric charges becomes smaller. As to the problem, that owing to a narrow channel effect that accompanies a finer width of the transfer electrode (dimension in a channel direction), an effective width of the potential barrier becomes smaller and thereby signal charges are likely to intrude into an adjacent potential well can be also a restricting factor of the handling amount of electric charges. Furthermore, when, for instance, to a variation of the channel potential from a time t1 to a time t2 and a variation of the channel potential from a time t2 to a time t3, a drift of signal charges from below a transfer electrode corresponding to φ₁ to below a transfer electrode corresponding to φ₂ cannot follow, a phenomenon in which the signal charges partially overcome a low potential barrier 2 and flow back to below the transfer electrode corresponding to φ₃ can occur. This also can be a restricting factor of a handling amount of electric charges.

[Patent literature 1] JP-A No. 2000-98976

### SUMMARY OF THE INVENTION

A clock generation circuit and a CCD driving circuit according to the invention include a voltage-setting circuit that sequentially sets a plurality of clock signal lines to predetermined clock voltages, a capacitor one end of which is commonly connected to the respective clock signal lines, a plurality of switches respectively connected between the capacitor and the respective clock signal lines and a switch control circuit that, in advance when the clock voltage set to anyone of the clock signal lines is switched by the voltage-setting circuit, temporarily turns on the switch corresponding to the clock signal line; and generates clock signals of plural phases.

According to the invention, before a certain phase (clock phase) of a clock signal that is supplied to a CCD as a transfer clock is turned off, electric charges charged in the corresponding clock signal line and the transfer electrode of the CCD are partially reserved once in the capacitor, and before a certain clock phase is turned on the electric charges of the capacitor are made use to charge the corresponding clock signal line and the transfer electrode. Thereby, as to the preservation of the electric charges from a certain clock phase to the capacitor and the reuse of the electric charges from the capacitor to a certain clock phase, a degree of freedom of the timing thereof and the clock phase relating to the charge/discharge can be obtained. In particular, in order to drive a CCD, the respective clock phases are necessary to be on/off operated in accordance with a predetermined sequence that has the interrelationship. According to the invention, while satisfying the sequence, the preservation and the reuse of the electric charges can be implemented to reduce the consumption power. Furthermore, as a result of an increase in a degree of freedom relative to the charge/discharge owing to the use of the capacitor, a depth of a potential well (or height of the potential barrier) and a fringe electric field can be secured and a handling amount of the electric charges and the charge transfer efficiency can be secured.

### BRIEF DESCRIPTION OF THE DRAWINGS

FIG. 1 is a timing chart of a three-phase transfer clock that an existing driving circuit supplies to a CCD.

FIG. 2 is a schematic diagram showing a temporal variation of a channel potential along a charge transfer direction according to an existing driving circuit.

FIG. 3 is a circuit diagram of an essential part of a liquid crystal driving circuit described in patent literature 1.

FIG. 4 is a timing chart describing an operation of a liquid crystal driving circuit described in the patent literature 1.

FIG. 5 is a schematic diagram showing a temporal variation of a channel potential along a charge transfer direction according to an existing driving method of a four-phase drive CCD.

FIG. 6 is a schematic diagram showing a temporal variation of a channel potential along a charge transfer direction when a technology of a liquid crystal driving circuit according to the patent literature 1 is applied to a four-phase drive CCD.

FIG. 7 is a timing chart showing the clocks when a clock generated by the liquid crystal driving circuit according to the patent literature 1 is applied to a three-phase drive CCD.

FIG. 8 is a schematic diagram showing a channel potential along a charge transfer direction when driven with a clock shown in FIG. 7.

FIG. 9 is a circuit diagram showing a schematic configuration of a CCD image sensor driving circuit that is a first embodiment.

FIG. 10 is a timing chart describing an operation of a driving circuit according to the first embodiment.

FIG. 11 is a schematic diagram showing a temporal variation of a channel potential along a charge transfer direction in the first embodiment.

FIG. 12 is a timing chart comparing waveforms of a transfer clock of a driving circuit according to the first embodiment and a transfer clock of an existing driving circuit.

FIG. 13 is a circuit diagram showing a schematic configuration of a CCD image sensor driving circuit that is a second embodiment.

FIG. 14 is a timing chart describing an operation of a driving circuit according to the second embodiment.

FIG. 15 is a circuit diagram showing a schematic configuration of a CCD image sensor driving circuit that is a third embodiment.

FIG. 16 is a timing chart describing an operation of a driving circuit according to the third embodiment.

FIG. 17 is a circuit diagram showing a schematic configuration of a CCD image sensor driving circuit that is a fourth embodiment.

FIG. 18 is a timing chart describing an operation of a driving circuit according to the fourth embodiment.

### DESCRIPTION OF THE PREFERRED EMBODIMENTS

In what follows, modes for implementations (hereinafter referred to as embodiments) of the invention will be described based on the drawings.

### Embodiment 1

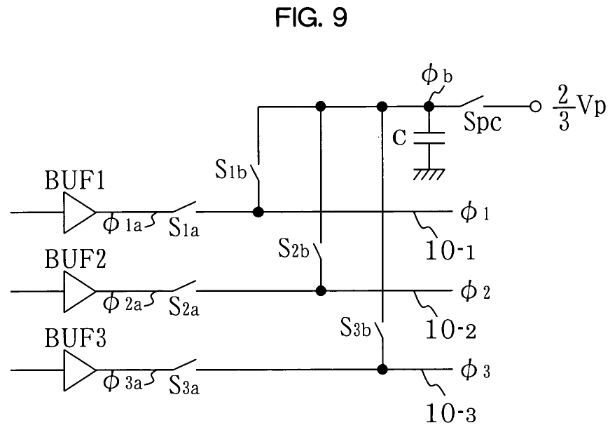

FIG. 9 is a circuit diagram showing a schematic configuration of a CCD image sensor driving circuit that is a first embodiment. The driving circuit generates transfer clocks φ₁ through φ₃ to a three-phase drive CCD vertical shift register constituting a frame-transfer type CCD image sensor. The driving circuit is constituted including buffers BUF1 through BUF3, switches S₁ₐ through S₃ₐ disposed between output terminals of buffers of the respective phases and clock signal lines 10₋₁ through 10₋₃, a capacitor C of which one end is connected commonly to the respective clock signal lines 10₋₁ through 10₋₃ and the other end thereof is grounded, switches S_{1b} through S_{3b} disposed respectively between the capacitor C and clock signal lines 10₋₁ through 10₋₃ of the respective phases, an initial charging circuit for charging the capacitor C (not shown in the drawing), a switch S_{pc} disposed between the capacitor C and the initial charging circuit, and a switch control circuit that controls on/off of the respective switches (not shown in the drawing). For reference's sake, each of the switches is constituted with a MOS transistor, and the switch control circuit generates a control signal to a gate of the transistor thereof and controls the on/off of the switch.

The buffers BUF1 through BUF3 each are operated in accordance with a timing signal from a not shown timing control circuit and generate clock pulses φ₁ₐ through φ₃ₐ of a voltage Vₚ. For reference's sake, a buffer BUFk (k=1, 2, 3) is a voltage-setting circuit that, when a switch Sₖₐ (k=1, 2, 3) is turned on, sets the clock signal lines 10₋ₖ (k=1, 2, 3) of the respective phases, which are respectively connected to the transfer electrodes of the CCD shift register to voltages of the clock φₖₐ (k=1, 2, 3).

The switches S₁ₐ through S₃ₐ connect and disconnect between the clock signal lines 10₋₁ through 10₋₃ connected to transfer electrodes of the respective phases of the CCD image sensor and the buffers BUF1 through BUF3. The switches S₁ₐ through S₃ₐ, as mentioned above, when turned on, conduct the clocks φ₁ₐ through φ₃ₐ outputted from the respective buffers BUF1 through BUF3 to the clock signal lines 10₋₁ through 10₋₃, and, when turned off, set the clock signal lines 10₋₁ through 10₋₃ and the transfer electrodes connected thereto to a floating state.

The switches S_{1b} through S_{3b} connect the clock signal line in a floating state and the capacitor C. Between the clock signal line 10₋ₖ and the capacitor C that are connected through a switch S_{kb}, electric charges move so that an equilibrium may be established between a potential φₖ of the clock signal line and a potential φ_{b} at one end of the capacitor C. That is, when the potential φₖ of the clock signal line 10₋ₖ is higher than the potential φ_{b} of the capacitor C, a current flows from the clock signal line 10₋ₖ to the capacitor C to charge the capacitor C. On the contrary, when the potential of the capacitor C is higher than that of the clock signal line, while the capacitor C is discharged, the clock signal line is charged. A resultantly obtained voltage is applied as a transfer clock φₖ (k=1, 2, 3) to the CCD. Owing to the charge/discharge of the capacitor C, the electric charges can be reused between the clock signal lines and thereby an amount of electric charges supplied from the buffers BUF1 through BUF3 to the respective clock signal lines 10₋₁ through 10₋₃ can be reduced; accordingly, the lower consumption power of the driving circuit can be achieved.

The capacitor C, during the operation of the CCD, as mentioned below, repeats a charge from a clock signal line set at a voltage Vₚ owing to the buffer and a discharge to a clock signal line set at a voltage 0 owing to the buffer. By repeating the charge/discharge, irrespective of an initial voltage of the capacitor C, the capacitor C gradually goes to a steady state. A potential φ_{b} at the steady state, at a timing when the capacitor C is charged from the clock signal line set at a voltage Vₚ, is a value V_{CH} shown below, and, at a timing when the capacitor C discharges to the clock signal line set at a voltage 0, is a value V_{CL} shown below. C_{L} appearing in the following equations is a capacitance relating to the clock signal line and includes a capacitance of the transfer electrode connected to the clock signal line.
V_{CH}=Vₚ(C_{L}+C)/(C_{L}+2C)
V_{CL}=Vₚ.C/(C_{L}+2C)

An initial charging circuit sets in advance at a drive start time a voltage in accordance with a state to which the capacitor C reaches in a steady driving state of the driving circuit, that is, in the range of V_{CL} to V_{CH}, or a voltage in the proximity thereof. Thereby, a time up to reaching a steady state of the capacitor C can be shortened, and thereby the CCD drive can be rapidly stabilized. The switch S_{pc} is turned on when the driving circuit starts operating and enables to charge the capacitor C from the initial charging circuit.

For instance, here, a driving circuit when a capacitor C is set same as a capacitance C_{L} of a clock signal line will be explained. In this case, since V_{CH} is 2Vₚ/3 and V_{CL} is Vₚ/3, for instance the initial charging circuit outputs a voltage V_{CH} to charge a potential φ_{b} of the capacitor C to 2Vₚ/3 at the time of drive start.

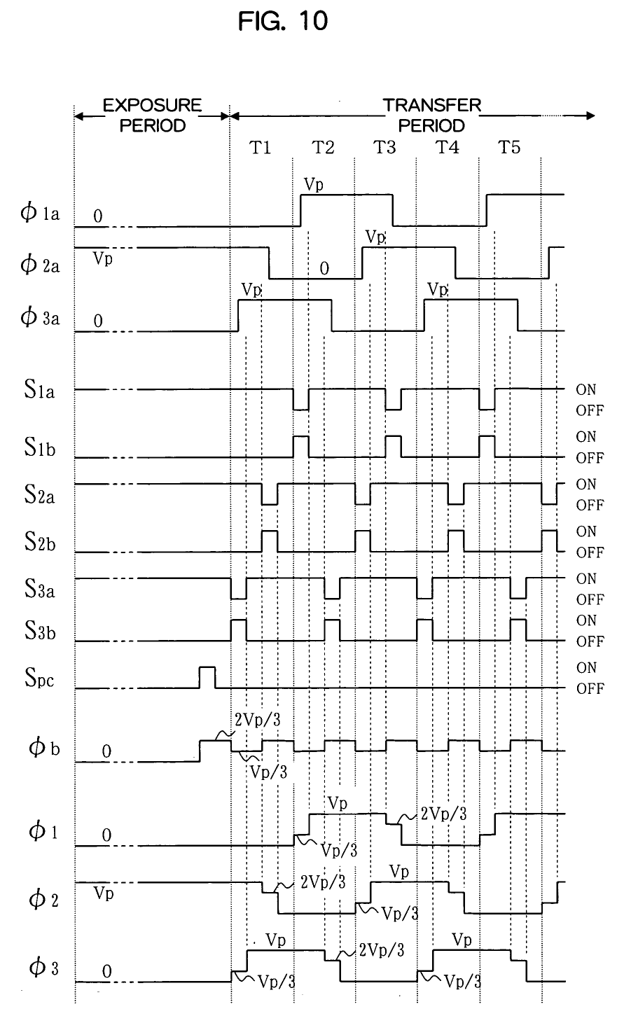

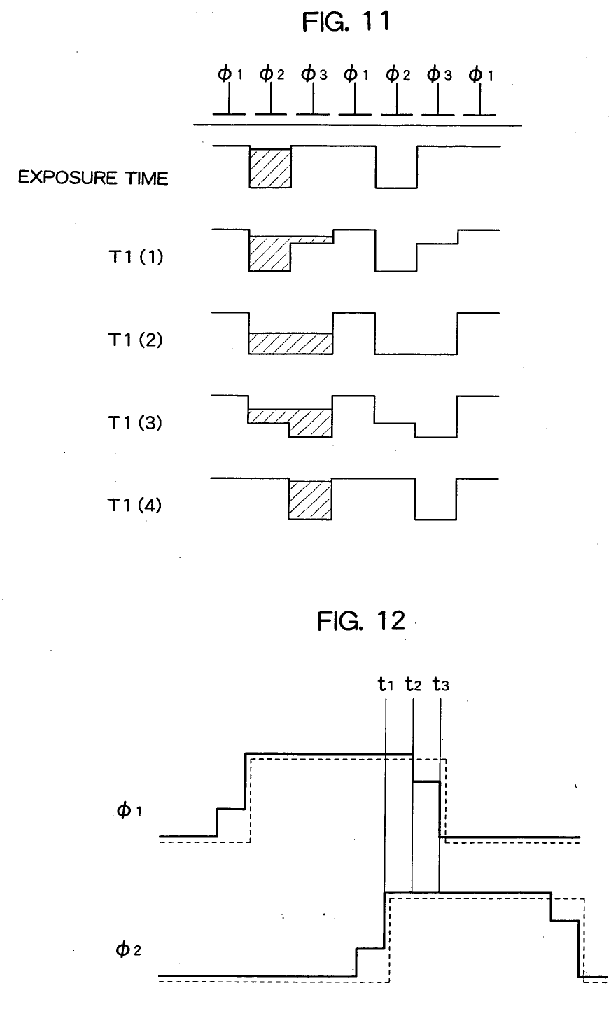

FIG. 10 is a timing chart for describing an operation of the driving circuit and represents a drive of a vertical shift register that constitutes an image pickup portion of a frame transfer type CCD image sensor. In the drawing, a signal attached with a note representing a switch represents a control signal to each of the switches, which is generated by the switch control circuit. When the control signal is at an H (High) level that is a predetermined positive voltage, the switch is turned on, and, on the other hand, when the control signal is at an L (Low) level that is a predetermined voltage lower than the H level, the switch is turned off. FIG. 11 is a schematic diagram showing a channel potential along a charge transfer direction at the respective timings shown in FIG. 10.

In an exposure period, Vₚ is applied to a second transfer electrode corresponding to φ₂ and thereby signal charges generated by the exposure are accumulated in a channel below the transfer electrode. When the exposure period comes to completion, a transfer period during which the signal charges are frame-transferred to a storage portion begins. During the transfer period, for every period Tj (j=1, 2, 3), the signal charges sequentially moves between the transfer electrodes, and, after three periods thereof, a vertical transfer of three transfer electrodes, that is, a portion of one cell comes to completion. Here, for the convenience of explanation, each of the periods Tj is divided into four intervals, and these are called a first through fourth timing from the beginning. In FIG. 11, an m-th timing of the period Tj is represented with a mark Tj(m).

At the beginning, when the exposure period comes to completion and the transfer period starts, the S_{pc} is turned on for a predetermined period to charge the capacitor C from the initial charging circuit, and thereby φ_{b} is set to 2Vₚ/3.

At an initial period T1 of the transfer period, signal charges move from below a second transfer electrode to a potential well below a third transfer electrode. At a first timing of the period T1, in accordance with a signal from the timing control circuit, the BUF3 transits φ₃ₐ from 0 to Vₚ. However, since at the first timing the S₃ₐ is in an off state, the clock signal line 10₋₃ is set to a floating state, and the φ₃ₐ is not applied to the clock signal line 10₋₃. On the other hand, during the S₃ₐ being in an off state, the S_{3b} is turned on and the clock signal line 10₋₃ is connected to the capacitor C. Thereby, the clock signal line 10₋₃ is charged from the capacitor C at the first timing, and φ₃ is raised from 0 to Vₚ/3. At this time, the potential φ_{b} of the capacitor C, owing to the discharge, comes down to a voltage Vₚ/3 same as that of the clock signal line 10₋₃.

At a subsequent second timing, the S_{3b} is turned off, the S₃ₐ is turned on, the φ₃ becomes φ₃ₐ set at the first timing, namely, Vₚ, and the signal charges are stored below the second and third transfer electrodes.

At the third and fourth timings of the T1, the second transfer electrode is turned off. At the third timing, in accordance with a signal from the timing control circuit, the BUF2 causes φ₂ₐ to transit from Vₚ to 0. However, since the S₂ₐ is set to an off state at the third timing, the clock signal line 10₋₂ is set to a floating state and the φ₂ₐ is not applied to the clock signal line 10₋₂. On the other hand, while the S₂ₐ is being turned off, the S_{2b} is turned on and the clock signal line 10₋₂ is connected to the capacitor C. Thereby, the clock signal line 10₋₂ discharges to the capacitor C at the third timing and thereby the φ₂ is lowered from Vₚ to 2Vₚ/3. At this time, a potential φ_{b} of the capacitor C is charged up to a potential 2Vₚ/3 same as that of the clock signal line 10₋₂.

At the subsequent fourth timing, the S_{2b} is turned off and the S₂ₐ is turned on, the φ₂ becomes the φ₂ₐ set at the third timing, that is, 0, thereby the potential well below the second transfer electrode disappears, and the signal charges move from below the second transfer electrode to below the third transfer electrode.

According to a procedure same as that of the operation at the above-mentioned period T1, at the period T2, from below the third transfer electrode to a potential well below the first transfer electrode, the signal charges move, and at the period T3, from below the first transfer electrode to a potential well below the second transfer electrode, the signal charges move. After the period T4, operations of the periods T1 through T3 are repeated.

At a rising time of each of the transfer clocks φₖ, at the beginning, owing to charge from the capacitor C, the φₖ becomes Vₚ/3. Thereafter, owing to the charge from the BUFk, the φₖ further goes up by 2Vₚ/3 to be Vₚ. That is, a current amount supplied by the BUFk can be only two third that according to an existing method, and thereby the consumption power is reduced by one third. At a falling time, initially, the clock signal line charges the capacitor C, and thereby φ_{b} goes up by Vₚ/3 and the φₖ becomes 2Vₚ/3. Thereafter, the clock signal line discharges through the BUFk and thereby the φₖ becomes 0. An increase in charge of the capacitor C at the falling time is reused to charge at the rising time of a subsequent transfer clock.

According to the transfer clock generated at the driving circuit, as shown in FIG. 11, as a height of a potential barrier separating between adjacent potential wells, a portion of a potential difference Vₚ of the transfer clock can be secured at any of timings.

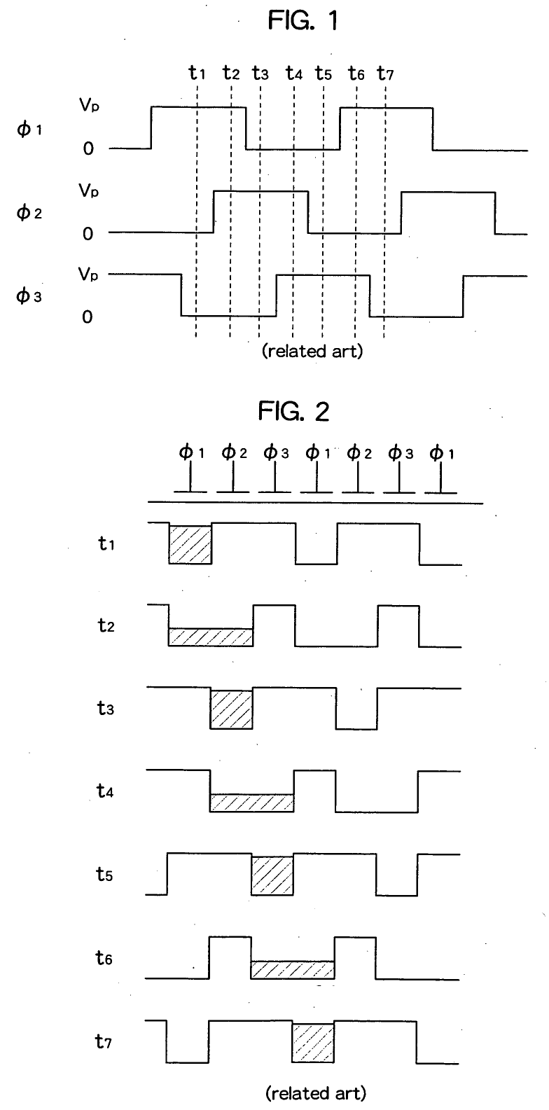

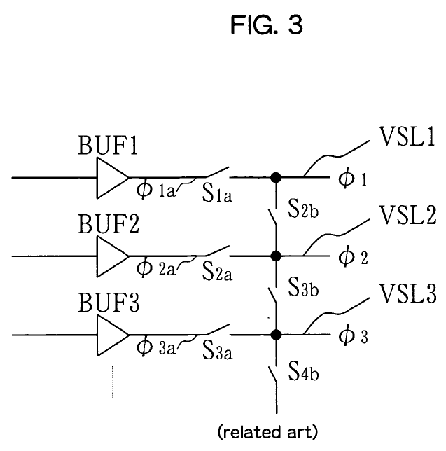

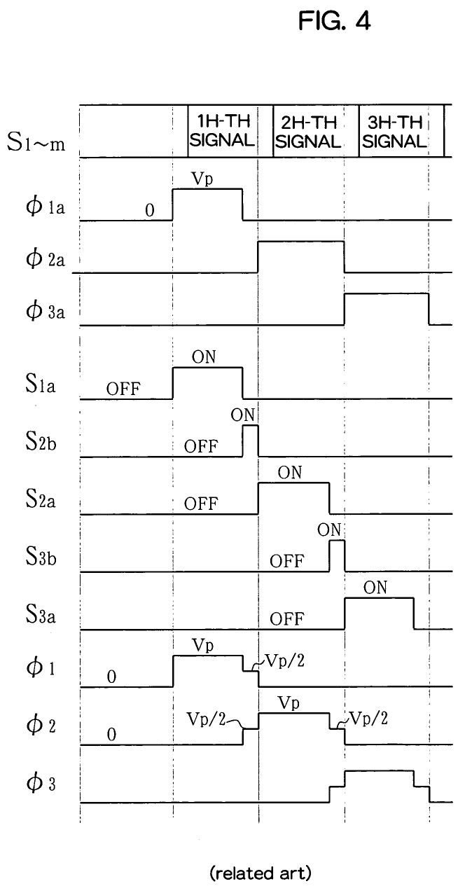

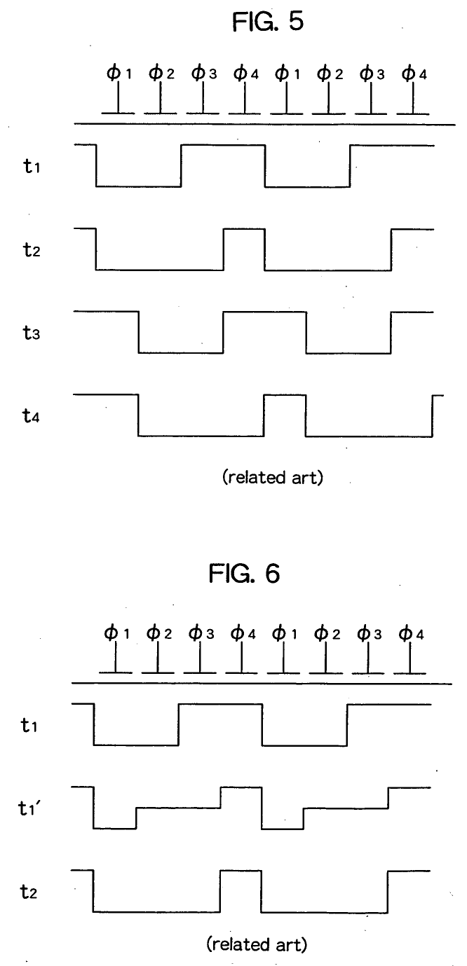

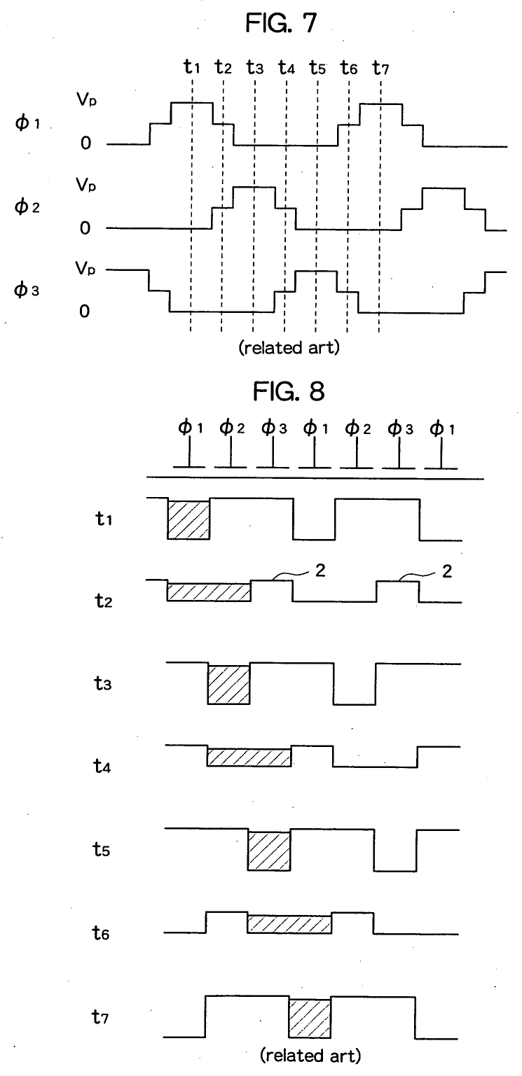

Next, the charge transfer efficiency will be described. FIG. 12 is a timing chart comparing waveforms of a transfer clock of a driving circuit according to the invention and a transfer clock of an existing driving circuit. Here, φ₁ and φ₂ of the respective transfer clocks are shown, and, with this, a transfer operation of the signal charges from a first phase transfer electrode G1 to a second phase transfer electrode G2 will be described. In the drawing, solid lines represent the transfer clocks according to the invention and chain lines represent existing transfer clocks shown in FIG. 1. So far, after the signal charges are stored below both the G1 and G2 during t1 to t3, at a time t3, φ₁ is changed from Vₚ to 0. In the course where the potential well below the G1 disappears owing to switching of the φ₁, the signal charges move from the G1 to the G2 and thereby the signal charges are stored only below the G2.

In comparison with the existing transfer operation, according to the present driving circuit, the movement of the signal charges from the G1 to the G2 accompanying the disappearance of the potential well below the G1 is initiated by setting the φ₁ to 2Vₚ/3 at a time t2 preceding an existing start time t3 and accelerated when the φ₁ is further lowered to 0 at the time t3. From a different viewpoint, according to the present driving circuit, a substantial time during which the signal charges are stored below both the G1 and G2 is shortened, and a shortened portion thereof is assigned to the movement of the signal charges. Thereby, a smooth transfer of signal charges can be realized and thereby the transfer efficiency can be improved.

### Embodiment 2

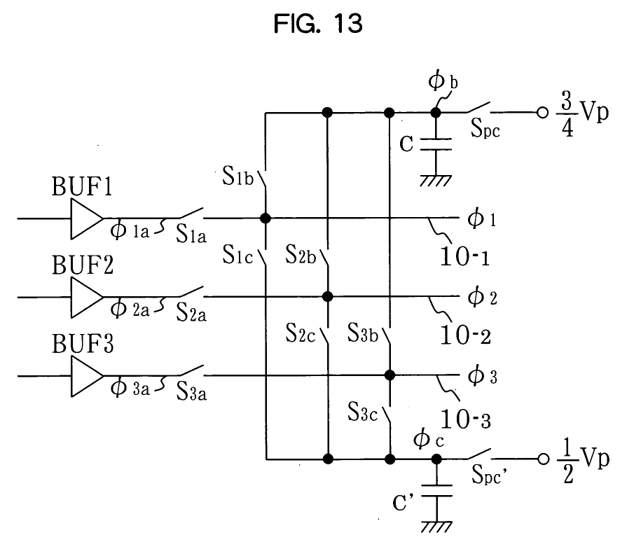

FIG. 13 is a circuit diagram showing a schematic configuration of a CCD image sensor driving circuit that is a second embodiment. The driving circuit generates transfer clocks φ₁ through φ₃ to a three-phase drive CCD vertical shift register that constitutes a frame transfer type CCD image sensor and has portions common to the driving circuit according to the first embodiment. Accordingly, in what follows, with points different from the driving circuit according to the first embodiment at a center, the description will be given. The driving circuit includes, in addition to the configuration of the driving circuit according to the first embodiment, a second capacitor C′ one end of which is connected commonly to the respective clock signal lines 10₋₁ through 10₋₃ and the other end thereof is grounded; switches S_{1c} through S_{3c} disposed between the capacitor C′ and each of the clock signal lines 10₋₁ through 10₋₃ of the respective phases; a second initial charging circuit (not shown in the drawing) for charging the capacitor C′ and a switch S_{pc}′ disposed between the capacitor C′ and the initial charging circuit.

Buffers BUF1 through BUF3, respectively, operate in accordance with a timing signal from a not shown timing control circuit to generate clock pulses φ₁ₐ through φ₃ₐ with a voltage Vₚ. For reference's sake, a buffer BUFk (k=1, 2, 3) is a voltage-setting circuit that sets, when a switch Sₖₐ (k=1, 2, 3) is turned on, the clock signal lines 10₋ₖ (k=1, 2, 3) of the respective phases, which are respectively connected to the transfer electrodes of the CCD shift register, to a voltage of the clock φₖ (k=1, 2, 3).

The switches S_{1c} through S_{3c} connect the clock signal lines in a floating state and the capacitor C′. Between the clock signal line 10₋ₖ and the capacitor C′ connected via a switch S_{kc}, the electric charges move so that an equilibrium may be established between a potential φₖ of the clock signal line and a potential φ_{c} at one end of the capacitor C′. A resultantly obtained voltage is applied to a CCD as a transfer clock φₖ. The charge/discharge of the capacitor C′, similarly to the charge/discharge of the capacitor C, realizes the reuse of the electric charges between the clock signal lines and thereby reduces the consumption power of the driving circuit.

As one example, here, a driving circuit where the capacitor C′, similarly to the capacitor C, is set to a capacitance C_{L} of the clock signal line will be described.

A steady state achieved when the capacitors C and C′ repeat the charge/discharge depends on an order of the charge/discharge of both capacitors. In the driving circuit, at the rising time of each of the transfer clocks φₖ, at first the capacitor C′ charges the clock signal line followed by charging the clock signal line from the capacitor C. On the other hand, at the falling time, firstly the clock signal line discharges to the capacitor C followed by discharging the clock signal line to the capacitor C′. That is, an order of connecting the capacitors C and C′ to the clock signal line is reversed between charge and discharge. In a steady state at this time, the potential φ_{b} of the capacitor C, in accordance with the charge/discharge, alternately takes two values of 3Vₚ/4 and Vₚ/2, and the potential φ_{c} of the capacitor C′, in accordance with the charge/discharge, alternately takes two values of Vₚ/2 and Vₚ/4.

Corresponding thereto, when the switches S_{pc} and S_{pc}′ to the both capacitors are turned on at the completion of the exposure period, the initial charging circuit to the capacitor C is constituted so as to set, for instance, a voltage 3Vₚ/4 to the capacitor C, and the initial charging circuit to the capacitor C′ is constituted so as to set, for instance, a voltage Vₚ/2 to the capacitor C′. Thereby, similarly to the first embodiment, a time necessary for each of the capacitors to reach a steady state thereof can be shortened, and thereby the CCD drive can be rapidly stabilized.

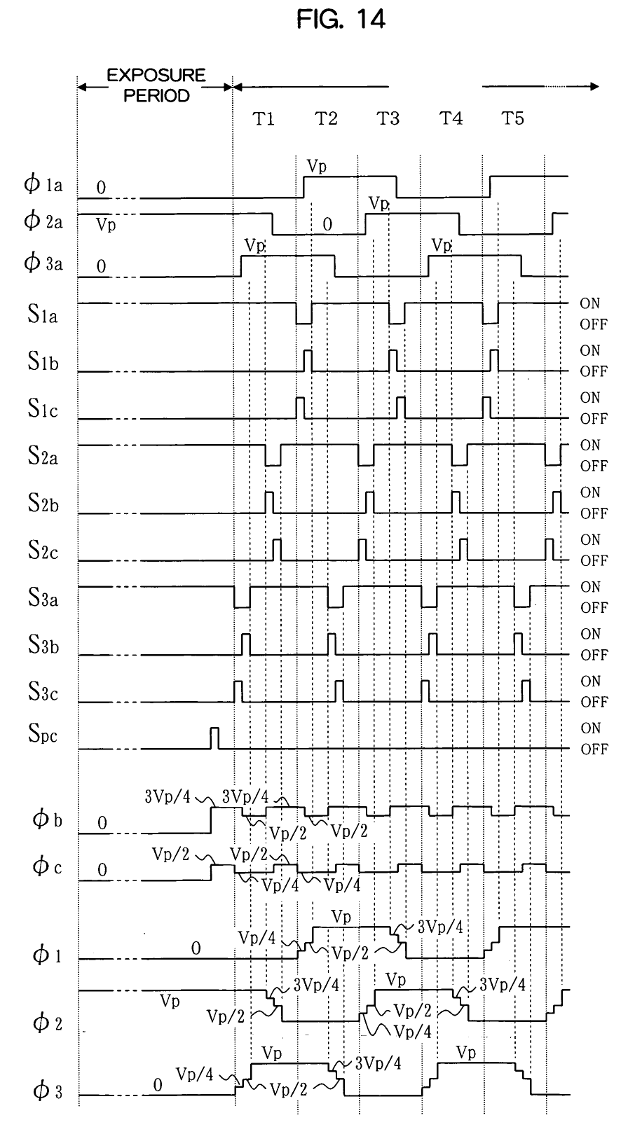

FIG. 14 is a timing chart for describing an operation of the driving circuit, and, similarly to FIG. 10, represents a drive of a vertical shift register that constitutes an image pickup portion of the frame transfer type CCD image sensor.

When the exposure period comes to completion, a transfer period where the signal charges accumulated by the exposure in a channel below the second transfer electrode are frame-transferred to a storage portion begins. Similarly to the first embodiment, a vertical transfer of a portion of one cell comes to completion within three cycles of period Tj. Here, as well, each of the periods Tj is divided into a first through a fourth timing.

One point where an operation of the driving circuit is different from that of the first embodiment is present in that each of charge/discharge of each of the clock signal lines is carried out in two-stages between the capacitors C and C′. Specifically, at a first period T1 of the transfer period, when the transfer clock φ₃ is raised to move the signal charges to a potential well below the third transfer electrode, at the first timing, an operation of turning on/off the S_{3c} and an operation of turning on/off the S_{3b} are sequentially applied in this order. Furthermore, when, in order to make the potential well below the second transfer electrode disappear at the period T1, the transfer clock φ₂ is lowered, at the third timing, an operation of turning on/off the S_{2b} and an operation of turning on/off the S_{2c} are sequentially applied in this order.

A charging operation of the clock signal line 10₋₃ at the first timing is carried out with the clock signal line setting to a floating state by turning off the S₃ₐ, the clock signal line 10₋₃ is charged from the capacitor C′ by a preceding on/off operation of the S_{3c}, and thereby the φ₃ comes up from 0 to Vₚ/4. At this time, a potential φ_{c} of the capacitor C′ comes down, owing to the discharge, to a potential Vₚ/4 same as that of the clock signal line 10₋₃. By a subsequent on/off operation of the S_{3b}, the clock signal line 10₋₃ is charged from the capacitor C, and thereby the φ₃ comes up to Vₚ/2. At this time, a potential φ_{b} of the capacitor C comes down, owing to the discharge, to a potential Vₚ/2 same as that of the clock signal line 10₋₃.

On the other hand, a discharging operation of the clock signal line 10₋₂ at the third timing is carried out with the clock signal line setting to a floating state by turning off the S₂ₐ, the clock signal line 10₋₂, by a preceding on/off operation of the S_{2b}, discharges to the capacitor C, and thereby the φ₂ comes down from Vₚ to 3Vₚ/4. At this time, a potential φ_{b} of the capacitor C, owing to the charge, comes up to a potential 3Vₚ/4 same as that of the clock signal line 10₋₂. By a subsequent on/off operation of S_{2c}, the clock signal line 10₋₂ discharges to the capacitor C′, and thereby the φ₂ comes down to Vₚ/2. At this time, a potential φ_{c} of the capacitor C′, owing to the discharge, comes up to a potential Vₚ/2 same as that of the clock signal line 10₋₂.

Similarly to the first embodiment, according to a procedure same as that in the operation at the period T1, in a period T2, signal charges are moved from below the third transfer electrode to a potential well below the first transfer electrode, and, in the period T3, the signal charges are moved from below the first transfer electrode to a potential well below the second transfer electrode. From the period T4 on, the operations of the periods T1 through T3 are repeated.

At the rising time of each transfer clocks φₖ, the φₖ is sequentially charged from the capacitors C and C′ and comes up to Vₚ/2. Thereafter, the φₖ further rises by Vₚ/2 owing to the charge from the BUFk to be Vₚ. That is, a current amount supplied from the BUFk is only one half an existing amount and one half of the consumption power can be reduced. In addition, an amount of decrease in the consumption power is larger than that in the first embodiment. At the falling time, initially, the clock signal line sequentially charges the capacitors C and C′, and thereby the φₖ becomes Vₚ/2. Thereafter, the clock signal line discharges through the BUFk and thereby φₖ becomes 0. An increase in charge of the capacitors C and C′ at the falling time are reused at the charging at the rising of a subsequent transfer clock.

Even when the charge and discharge of the capacitors C and C′ are carried out in the same order, that is, both the charge at the rising of the respective transfer clocks φₖ and the discharge at the falling time thereof are carried out in an order of the capacitor C′ followed by capacitor C, the reduction effect of the consumption power becomes larger than that of the first embodiment. However, the above configuration where an order is reversed at the charge and discharge can give a larger reduction effect.

Furthermore, also by the transfer clock generated in the driving circuit, similarly to the first embodiment, a height of a potential barrier separating adjacent potential wells can be secured by a portion of the potential difference Vₚ of the transfer clock at any of the timings.

Still furthermore, according to the driving circuit as well, similarly to the first embodiment, a smooth signal charge transfer can be realized and the transfer efficiency can be improved.

### Embodiment 3

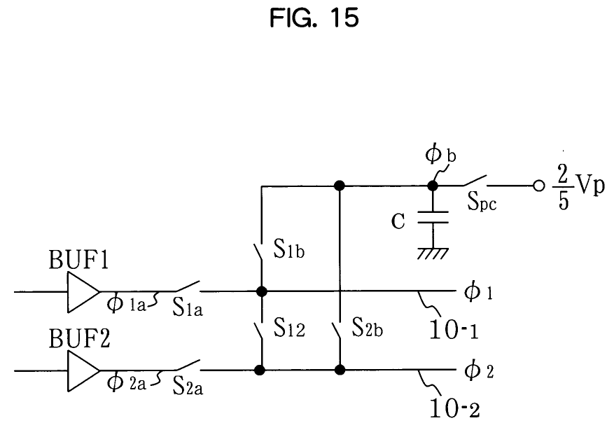

FIG. 15 is a circuit diagram showing a schematic configuration of a CCD image sensor driving circuit that is a third embodiment. The driving circuit generates transfer clocks φ₁ and φ₂ to a CCD shift register in order to two-phase drives a CCD image sensor having a group of transfer electrodes where pairs of a storage gate and a barrier gate that are mutually adjacent and connected to common signal lines are arranged. Same notes refer constituent elements common to that of the driving circuit according to the first embodiment to simplify the description.

The driving circuit is constituted including buffers BUF1 and BUF2, switches S₁ₐ and S₂ₐ disposed between output terminals of the buffers of the respective phases and clock signal lines 10₋₁ and 10₋₂, a capacitor C one end of which is connected commonly to the respective clock signal lines 10₋₁ and 10₋₂ and the other end of which is grounded, switches S_{1b} and S_{2b} disposed respectively between the capacitor C and the clock signal lines 10₋₁ and 10₋₂ of the respective phases, an initial charging circuit (not shown in the drawing) that is used to charge the capacitor C, a switch S_{pc} disposed between the capacitor C and the initial charging circuit, a switch S₁₂ disposed between two clock signal lines 10₋₁ and 10₋₂, and a switch control circuit (not shown in the drawing) that on/off controls the respective switches.

In the driving circuit, in accordance with the difference in the number of phases, fundamentally, a configuration involving the third phase clock of the driving circuit of the first embodiment is omitted, and, in addition to the above, a switch S₁₂ is included as a constituent element characteristic to the two-phase drive. In the two-phase drive, a rise of one clock phase and a fall of the other clock phase are fundamentally carried out in synchronization. Accordingly, without the capacitor C, direct delivery of electric charges between the clock signal lines can be realized. The S₁₂ is disposed to carry out the direct delivery of the electric charges between the clock signal lines.

In the initial charging circuit, an output voltage is set in accordance with a potential φ_{b} of the capacitor C at a steady state in an operation described below. Here, for instance, when the capacitor C is set to a capacitance same as C_{L} of the clock signal line, the initial charging circuit outputs a voltage of 2Vₚ/5.

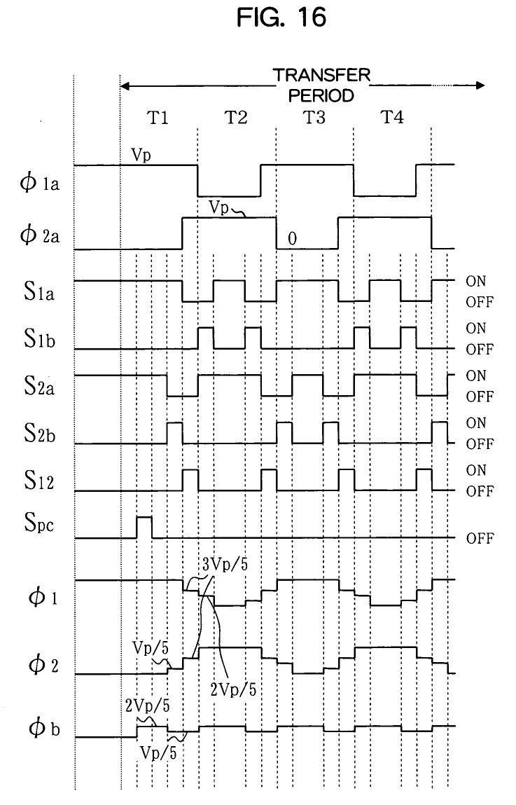

FIG. 16 is a timing chart for describing an operation of the driving circuit. Before the start of the transfer, Vₚ is applied to a first transfer electrode corresponding to φ₁ and thereby in a channel below the transfer electrode signal charges are stored. During the transfer period, in synchronization with the period Tj (J=1, 2, 3), the signal charges sequentially move between the transfer electrodes. Here, for the convenience of explanation, each of periods Tj is equally divided into five, and these are called a first through fifth timing from the beginning.

Firstly, for instance, at a second timing of the first period T1, the S_{pc} is turned on, the capacitor C is charged from the initial charging circuit, and thereby φ_{b} is set to 2Vₚ/5.

During initial periods T1 to T2 of the transfer period, signal charges are transferred from below the first transfer electrode to a potential well below the second transfer electrode. At the fourth and fifth timings, S₂ₐ is turned off and thereby the clock signal line 10₋₂ is set to a floating state. At the fourth timing, S_{2b} is turned on and thereby the clock signal line 10₋₂ is connected to the capacitor C. Thereby, the clock signal line 10₋₂ is charged at the fourth timing from the capacitor C, and thereby φ₂ comes up to Vₚ/5 from 0. At this time, a potential φ_{b} of the capacitor C comes down, owing to the discharge, to Vₚ/5 same as that of the clock signal line 10₋₂.

At the fifth timing, in addition to the S₂ₐ, the S₁ₐ is also turned off, and thereby both of the clock signal lines are set to a floating state. Furthermore, S_{2b} is turned off to isolate the clock signal line also from the capacitor C. In this state, S₁₂ is turned on and thereby charge and discharge are carried out between the clock signal lines. Here, from the clock signal line 10₋₁ of which potential φ₁ is Vₚ to the clock signal line 10₋₂ of which potential φ₂ is Vₚ/5, a current flows until a potential equilibrium is established, both potentials φ₁ and φ₂ becoming 3Vₚ/5.

At the first timing of the period T2, S₁₂ is turned off and thereby two clock signal lines are isolated from each other. Furthermore, S₂ₐ is turned on, φ₂ₐ that is transitioned from 0 to Vₚ by the BUF2 at the fifth timing of the T1 is applied to the clock signal line 10₋₂, and thereby φ₂ comes up to Vₚ. As to φ₁, while the S₁ₐ is still kept at an off state, S_{1b} is turned on, and thereby the clock signal line 10₋₁ is connected to the capacitor C of which φ_{b} is Vₚ/5. Thereby, the clock signal line 10₋₁ discharges to the capacitor C, both φ₁ and φ_{b} becoming 2Vₚ/5.

At a subsequent second timing, S_{1b} is turned off and S₁ₐ is turned on, φ₁ₐ transitioned from Vₚ to 0 by the BUF1 at the first timing of T2 is applied to the clock signal line 10₋₁, and thereby φ₁ comes down to 0.

At the second and third timings of T2, φ₁ is set to 0 and φ₂ is set to Vₚ, and thereby the signal charges are stored in a potential well below the second transfer electrode.

Owing to a series of operations from the fourth timing of T1 to the third timing of T2, the signal charges are transferred from below the first transfer electrode to below the second transfer electrode. Similarly, owing to operations from the fourth timing of T2 to the third timing of T3, the signal charges are transferred from below the second transfer electrode to below the first transfer electrode. Thus, thereafter, for every one period, the signal charges are alternately transferred between the transfer electrodes.

At the rising time of each of the transfer clocks φₖ generated according to the above operations, at first, owing to the charge from the capacitor C, φₖ becomes Vₚ/5. Thereafter, the clock signal line at the rising timing of φₖ is charged from the other clock signal line, and thereby φₖ becomes 3Vₚ/5. Thereafter, owing to the charge from the BUFk, φₖ further comes up by 2Vₚ/5 to be Vₚ. That is, a current amount supplied from the BUFk can be done with two fifth of an existing value, that is, three fifth of the consumption power is reduced. At the falling time of φₖ of the clock signal line, at first, the other clock signal line is charged, and thereby φₖ comes down from Vₚ to 3Vₚ/5. Thereafter, the clock signal line at the falling timing charges the capacitor C, and thereby φ_{b} comes up by Vₚ/5 and φₖ becomes 2Vₚ/5. Further thereafter, the clock signal line discharges through the BUFk and thereby φₖ becomes 0.

In the two-phase drive, a falling operation of one transfer clock and a rising operation of the other transfer clock are simultaneously carried out. In the driving circuit, at the timing where both operations overlap, the charge and discharge are directly carried out between the clock signal lines to achieve the reuse of the electric charges. Furthermore, when, by intermediating the capacitor C, a timing of discharge from the clock signal line and a timing of charge to the clock signal line are mutually displaced, the reuse of the electric charges can be realized.

For reference's sake, a horizontal transfer portion of the CCD image sensor, in order to realize a high-speed transfer, is ordinarily two-phase driven by connecting a pair of a storage gate and a barrier gate to one signal line. In the drive, driving circuits of the above-mentioned embodiment and a fourth embodiment described below can be applied. In general, in the two-phase driven horizontal transfer portion, two pairs of transfer electrodes are assigned to every column of the signal charges read in a vertical direction (column direction). When the two pairs of transfer electrodes are respectively driven at φ₁ and φ₂, the signal charges for every column can be transferred in a horizontal direction (row direction). On the other hand, when, for instance, the number of pixels during a preview operation is compressed to secure a high frame rate, a technology where the signal charges of plural columns adjacent in the horizontal transfer portion are mixed to improve a horizontal transfer speed is proposed. For instance, when the signal charges of adjacent two columns are mixed, a configuration where while G1 and G3 at odd numbered positions of four pairs of transfer electrodes G1 through G4 of the horizontal transfer portion corresponding to the two columns are enabled to be driven independently from each other by the two-phase transfer clocks φ₁ and φ₂, a fixed voltage intermediate of amplitudes of the transfer clocks φ₁ and φ₂ are applied to G2 and G4 at even numbered positions can be adopted. In the configuration, Vₚ is applied to G1 and G3 to read the signal charges corresponding to each one column below the storage gates of the G1 and G3. In this state, φ₁ is set to 0 V to set a channel potential below G1 shallower than G2 and G4, and thereby the signal charges below the G1 are mixed with the signal charges below the G3 located toward an output side than the G1. Furthermore, when φ₁ (or φ₂) is set to 0 V, a channel potential below the G1 (or G3) is set shallower than G2 and G4, φ₂ (or φ₁) is set to Vₚ and a potential of the G3 (or G1) is set deeper than the G2 and G4, combined signal charges can be transferred from below the G1 (or G3) to the G3 (or G1). That is, with one cycle of two-phase transfer clock, a portion of one set of four transfer electrodes that is twice the ordinary drive can be transferred in a horizontal direction.

To the two-phase drive where the potentials of transfer electrodes are partially fixed as well, driving devices according to the embodiment and a fourth embodiment can be applied.

### Embodiment 4

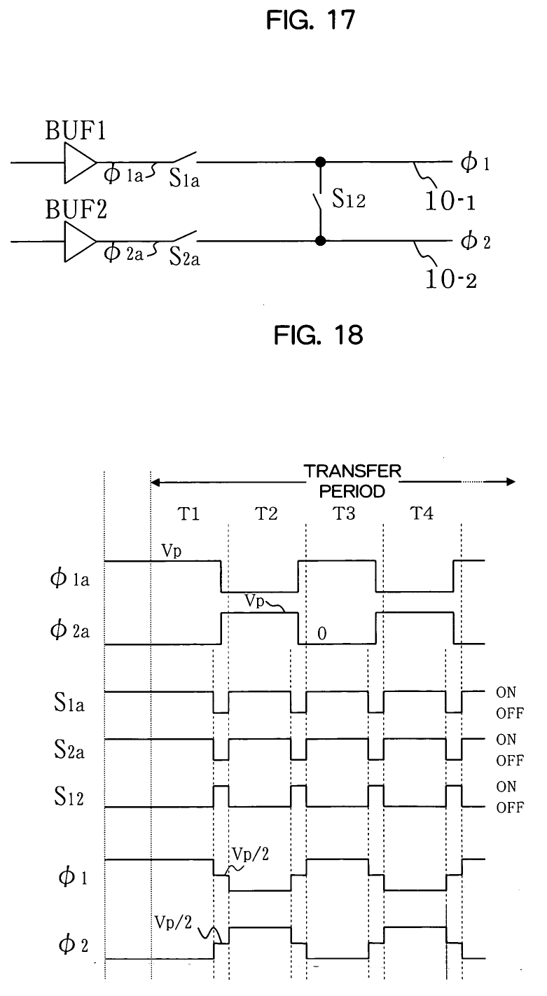

FIG. 17 is a circuit diagram showing a schematic configuration of a CCD image sensor driving circuit according to a fourth embodiment. The driving circuit, similarly to the third embodiment, generates transfer clocks φ₁ and φ₂ to a CCD shift register that two-phase drives a CCD image sensor where pairs of a storage gate and a barrier gate are arranged. The capacitor C and constituent elements accompanying thereto, that is, S_{1b}, S_{2b}, S_{pc} and the initial charging circuit of the driving circuit according to the third embodiment are omitted to simplify.

FIG. 18 is a timing chart for explaining an operation of the driving circuit. In the driving circuit, in accordance with rises and falls of φ₁ₐ and φ₂ₐ outputted from BUF1 and BUF2, S₁ₐ and S₂ₐ are turned off to set both clock signal lines to a floating state, and S₁₂ is turned on. Thereby, before switched φ₁ₐ and φ₂ₐ are applied to the respective clock signal lines, owing to the charge and discharge between the clock signal lines, potentials φ₁ and φ₂ of both of the clock signal lines are set to Vₚ/2. That is, when the potential φₖ of the clock signal line is switched from Vₚ to 0, firstly, one half of the electric charges stored in the clock signal line is discharged to the other clock signal line, and thereby φₖ is set to Vₚ/2. Thereafter, after S₁₂ is turned off, the clock signal line is connected to an output of the BUFk, and thereby φₖ is set to 0. On the other hand, when the φₖ of the clock signal line is switched from 0 to Vₚ, owing to the charge from the other clock signal line through the S₁₂, φₖ is set to Vₚ/2. Thereafter, after the S₁₂ is turned off, the clock signal line is connected to an output of the BUFk, and thereby φₖ is set to Vₚ. Thus, in the driving circuit, one half of the electric charges are reused between both the clock signal lines, and thereby the consumption power can be saved by one half.

In the descriptions of the above-mentioned respective embodiments, although the buffers BUFk and the switches Sₖₐ are separately configured, it goes without saying that they can be configured an integral circuit such as a buffer circuit of a try-state output.

Furthermore, in each of the embodiments, although the CCD image sensor driving circuit is exemplified, the invention can be applied to circuits that generate clocks of other plural phases. Specifically, the clock generation circuit includes a voltage-setting circuit that sequentially sets a plurality of clock signal lines to predetermined clock voltages, a capacitor one end of which is connected commonly to the respective clock signal lines, a plurality of switches respectively connected between the capacitor and the respective clock signal lines and a switch control circuit that, prior to switching the clock voltage set to any one of the clock signal lines by the voltage-setting circuit, temporarily turns on the switch corresponding to the clock signal line; and generates clock signals of plural phases.

According to the clock generation circuit, before a certain phase (clock phase) of a clock signal is turned off, electric charges charged to a corresponding clock signal line are once reserved partially in a capacitor, and, before a clock phase is turned on, the electric charges of the capacitor are used to charge the corresponding clock signal line. Thereby, as to the preservation of the electric charges from a certain clock phase to a capacitor and the reuse of the electric charges from the capacitor to a certain clock phase, a degree of freedom relating to the timing thereof and the clock phase of the charge/discharge can be obtained.

The CCD driving circuits described in the first through third embodiments are driving circuits that generate transfer clocks of plural phases to a group of transfer electrodes of the CCD to drive the CCD. The CCD driving circuit includes a voltage-setting circuit that sequentially sets the respective clock signal lines that conduct the transfer clocks of plural phases respectively to the corresponding transfer electrodes to predetermined clock voltages, a capacitor one end of which is connected commonly to the respective clock signal lines, a plurality of switches respectively connected between the capacitor and the respective clock signal lines and a switch control circuit that, in advance when the clock voltage set to any one of the clock signal lines is switched by the voltage-setting circuit, temporarily turns on the switch corresponding to the clock signal line.

According to the CCD driving circuit, before a certain phase (clock phase) of the transfer clock is turned off, electric charges charged to a corresponding clock signal line and a transfer electrode are once partially reserved in a capacitor, and, before a clock phase is turned on, the electric charges of the capacitor are used to charge the corresponding clock signal line and the transfer electrode. Thereby, as to the preservation of the electric charges from a certain clock phase to a capacitor and the reuse of the electric charges from the capacitor to a certain clock phase, a degree of freedom relating to the timing thereof and the clock phase of charge/discharge can be obtained. That is, from a viewpoint of the drive of the CCD, the respective clock phases are required to on/off operate according to a predetermined sequence having the interrelation. In this case, while satisfying the sequence, the preservation and reuse of the electric charges can be carried out, and thereby the consumption power can be reduced. Furthermore, as a result of an increase in the degree of freedom involving the charge/discharge owing to the use of the capacitor, a depth of a potential well (or height of a potential barrier) and a fringe electric field can be secured and a handling amount of electric charges and the charge transfer efficiency can be secured. As described with respect to the third embodiment, in the CCD, a group of transfer electrodes may be applied partially with, not a clock voltage of which voltage periodically varies, a fixed voltage. In that case, the CCD driving circuit supplies a transfer clock to the transfer electrodes other than the transfer electrodes to which a fixed voltage is supplied.

In a preferable constitution of the CCD driving circuit according to the invention, the clock signal line, when the corresponding switch is turned on, is set to a floating state.

In the CCD driving circuit according to the second embodiment, the capacitors are plurally disposed, the plurality of switches is disposed respectively corresponding to the plurality of capacitors, and the switch control circuit, at a time of switching the clock voltage, turns on alternately the plurality of switches corresponding to each of the clock signal lines in a predetermined order. According to the configuration, the preservation of the electric charges of the clock signal line and the transfer electrode and charge thereof are carried out in multi-stages, the reuse efficiency of the electric charges is improved, and the reduction effect of the consumption power can be heightened.

Furthermore, as mentioned in the second embodiment, in the CCD driving circuit where a plurality of the capacitors is disposed, the switch control circuit may have a configuration where a plurality of the switches corresponding to each of the clock signal lines is turned on in a reverse order when the clock voltage is switched to an high voltage from when the clock voltage is switched to an low voltage. According to the configuration, the efficiency of the multi-stage reuse of electric charges when a plurality of capacitors is used can be further improved.

The CCD driving circuits according to the first through third embodiments have a charging circuit that charges the capacitor, at the start of the drive of the CCD, to a voltage corresponding to a state to which the capacitor reaches under a steady drive state. According to the charging circuit, after the start of the drive, a stable driving state can be rapidly realized.

Furthermore, in the third embodiment, in the driving circuit to a CCD that is driven with the transfer clocks of two phases, a configuration that has a switch between signal lines, which is connected between the clock signal lines of each of two phases, and, when the switch control circuit switches the clock voltages set to the respective clock signal lines by the voltage-setting circuit, turns on the respective switches corresponding to the respective clock signal lines and the switches between signal lines alternately in a predetermined order is shown.

In the two-phase drive, a rise of one clock phase and a fall of the other clock phase are fundamentally carried out in synchronization. Accordingly, a direct delivery of the electric charges between the clock signal lines can be realized. According to a configuration of the third embodiment that has the switch between signal lines, owing to the charge and discharge with the capacitor and the charge and discharge between the clock signal lines, the multi-stage reuse of the electric charges can be realized and thereby the reuse efficiency thereof can be improved.

The CCD driving circuit according to the fourth embodiment is a driving circuit that generates transfer clocks of two phases to a transfer electrode group of the CCD to drive the CCD, and includes a voltage-setting circuit that sequentially sets the respective clock signal lines that conduct the transfer clocks of two phases respectively to the corresponding transfer electrodes to predetermined clock voltages, a switch between signal lines, which is connected to between the clock signal lines of each of two phases, and a switch control circuit that, prior to the switching of the clock voltage set to the respective clock signal lines by the voltage-setting circuit, temporarily turns on the switch between signal lines.

As a preferable configuration in the third and fourth embodiments, the CCD driving circuit where the clock signal line, when the switch between the signal lines is turned on, is set to a floating state is shown.

According to the above-mentioned CCD driving circuit, while inhibiting the charge transfer efficiency and a handling amount of electric charges from deteriorating, the consumption power can be reduced.

What is claimed is:

1. A clock generation circuit comprising:
a voltage-setting circuit that sequentially sets a plurality of clock signal lines to a predetermined clock voltage;
a capacitor one end of which is connected commonly to the respective clock signal lines;
a plurality of switches respectively connected between the capacitor and the respective clock signal lines; and
a switch control circuit that, in advance when the clock voltage set to any one of the clock signal lines is switched by the voltage-setting circuit, temporarily turns on the switch corresponding to the clock signal line;
wherein the clock generation circuit generates clock signals of plural phases.

2. A charge coupled device driving circuit that generates transfer clocks of plural phases to a transfer electrode group of the charge coupled device and drives the charge coupled device comprising:
a voltage-setting circuit that sequentially sets the respective clock signal lines that conduct the transfer clocks of plural phases to the respectively corresponding transfer electrodes to a predetermined clock voltage;
a capacitor one end of which is connected commonly to the respective clock signal lines;
a plurality of switches respectively connected between the capacitor and the respective clock signal lines; and
a switch control circuit that, in advance when the clock voltage set to any one of the clock signal lines is switched by the voltage-setting circuit, temporarily turns on the switch corresponding to the clock signal line.

3. The charge coupled device driving circuit according to claim 2, wherein the clock signal line, when the corresponding switch is turned on, is set to a floating state.

4. The charge coupled device driving circuit according to claim 2, wherein
the capacitor is plurally disposed;
the plurality of switches is disposed corresponding to each of the plurality of capacitors; and
the switch control circuit, when the clock voltage is switched, alternately turns on the plurality of switches corresponding to each of the clock signal lines in a predetermined order.

5. The charge coupled device driving circuit according to claim 4, wherein the switch control circuit turns on the plurality of the switches corresponding to each of the clock signal lines in a reverse order when the clock voltage is switched to an high-voltage from when it is switched to an low-state.

6. The charge coupled device driving circuit according to claim 2, further comprising:
a charging circuit that, at the drive start of the charge coupled device, charges the capacitor to a voltage in accordance with a state where the capacitor reaches in a steady drive state.

7. The charge coupled device driving circuit according to claim 2 and to the charge coupled device driven by the transfer clock of two-phases, further comprising:
a switch between signal lines, which is connected between the clock signal lines of each of two phases;
wherein the switch control circuit, when the clock voltages set to the respective clock signal lines by the voltage-setting circuit are switched, turns on the respective switches corresponding to the respective clock signal lines and the switch between signal lines alternately in a predetermined order.

8. A charge coupled device driving circuit that generates a transfer clock of two phases to a transfer electrode group of a charge coupled device and drives the charge coupled device, comprising:
a voltage-setting circuit that sequentially sets the respective clock signal lines that conduct the transfer clocks of two phases to the respectively corresponding transfer electrodes to a predetermined clock voltage;
a switch between signal lines, which is connected to between the clock signal lines of each of two phases; and
a switch control circuit that, in advance when the clock voltages set to the respective clock signal lines by the voltage-setting circuit are switched, temporarily turns on the switch between signal lines.

9. The charge coupled device driving circuit according to claim 7, wherein the clock signal line, when the switch between signal lines is turned on, is set to a floating state.

10. The charge coupled device driving circuit according to claim 8, wherein the clock signal line, when the switch between signal lines is turned on, is set to a floating state.
